(19) United States
(12) Patent Application Publication
(10) Pub. No.: US 2005/0046325 A1
(43) Pub. Date: Mar. 3, 2005

(54) Press-on stem clip for hid lamp

(76) Inventors: Ebon L. McCullough, New Ipswich, NH (US); Glen P. Williamson, Manchester, NH (US)

Correspondence Address: William H. McNeill;OSRAM SYLVANIA Inc., 100 Endicott Street, Danvers, MA, 01923, US

(21) Appl. No.: 10/649,521

(22) Filed: Aug. 26, 2003

(51) Int. Cl. H01J 5/48; H01J 5/50

(52) U.S. Cl. 313/318.09

(57) ABSTRACT

A frame clip (100) for mounting a light source (for example, an arc tube 32) in a lamp. The frame clip (100) comprises a substantially oval body having a longitudinal axis (110) with an opening (112) therein parallel to the longitudinal axis and having a given height, a first inside dimension D₁ and a second inside dimension D₂, and wherein the second dimension D₂ is greater than D₁.

This invention relates to lamps and more particularly to mount assemblies for arc discharge lamps. Still more particularly it relates to mount assemblies that are economical to fabricate, suitable for automation, and easily mounted to low-wattage lamps.

### BACKGROUND ART

Mount assemblies for arc discharge lamps usually employ a discharge vessel mounted upon a frame. The frame is generally mounted by means of clips to the flare. The flare itself comprises a tubular body that can carry the exhaust tubulation and seals the in-leads in a pinch seal. Previous assemblies have used bands and frame assemblies that were crimped onto a stem. Often, these assemblies were purchased parts that occasionally suffered damage in shipping. Further, the crimping and strapping operations necessary to mount the assembly to the stem have not been reasonably automatable. Such assemblies are expensive and require a great deal of manual operations to complete. The repetitious hand operations also had unacceptable ergonomic issues.

### DISCLOSURE OF INVENTION

It is, therefore, an object of the invention to obviate the disadvantages of the prior art.

It is another object of the invention to enhance the assembly of arc discharge lamps.

It is yet another object of the invention to provide a mount assembly that is suitable for automated construction.

It is a further object of the invention to provide a clip that mounts with a single action.

These objects are accomplished, in one aspect of the invention, by the provision of a frame clip for mounting a light source in a lamp, the frame clip comprising a substantially oval body having a longitudinal axis with an opening in the body parallel to the longitudinal axis and having a given height and a first inside dimension D₁ and a second inside dimension D₂, and wherein the second dimension D₂ is greater than D₁. The dimension D1 is less than the smallest dimension of the flare barrel and the dimension D2 is larger than the widest portion of the press-seal.

The objects are further accomplished in another aspect of the invention wherein a mount assembly for a lamp comprises a glass stem having a first portion that is tubular with an outside dimension D and a second formed as a pinch seal. A frame clip is mounted upon the first portion. The frame clip comprises a substantially oval body having a longitudinal axis with an opening in the body parallel to the longitudinal axis and having a given height and a first inside dimension D₁ and a second inside dimension D₂, and wherein the second dimension D₂ is greater than D₁ and D₁ is less than D before said frame clip is mounted upon said glass stem and wherein said first and second dimensions D₁ and D₂ are substantially equal to D after mounting.

This clip and mount assembly provide significant advantages over the prior devices. The clip can be pushed onto the barrel of the flare over the pinch-seal in a single motion since the largest of the differing oval dimensions is greater than the largest dimension of the pinch-seal. The barrel dimension that is greater than the narrowest dimension of the oval-shaped clip creates interference resulting in the deformed shape creating friction between the barrel glass and the clip. This design ensures that that there is an interference fit between the clip and the barrel that accommodates all of the barrel variation for dimension and out-of-roundness dimensions. Further, the clip is easy to manufacture and easy to automate, thereby reducing the cost of the lamp with which it is used.

### BRIEF DESCRIPTION OF THE DRAWINGS

FIG. 1 is plan view of an embodiment of the invention; and

FIG. 2 is an elevational view of a clip in accordance with an aspect of the invention mounted upon a flare.

### BEST MODE FOR CARRYING OUT THE INVENTION

For a better understanding of the present invention, together with other and further objects, advantages and capabilities thereof reference is made to the following disclosure and appended claims in conjunction with the above-described drawings.

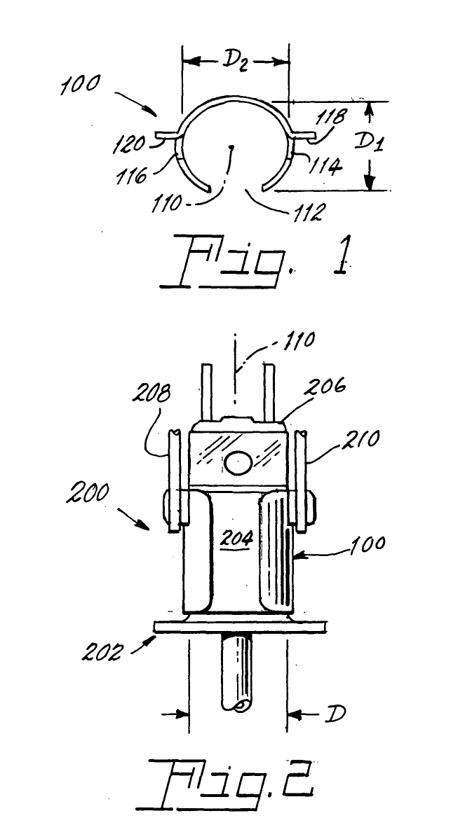

Referring now to the drawings with greater particularity, there is shown in FIG. 1 a frame clip 100 for mounting a light source (for example, an arc tube) in a lamp. The frame clip 100 comprises a substantially oval body having a longitudinal axis 110 with an opening 112 therein parallel to the longitudinal axis and having a given height, a first inside dimension D₁ and a second inside dimension D₂, and wherein the second dimension D₂ is greater than D₁.

In a preferred embodiment of the invention the frame clip 100 is manufactured from stainless steel and is 0.020 inches thick. Generally, D₁ is from 84 to 86% of D₂. In a preferred embodiment, where the frame clip is designed for use with a medium wattage arc discharge lamp, D₁ is 0.491 inches and D₂ is 0.571 inches. These dimensions will accommodate flare barrels having a dimension of 0.531 inches (13.46 mm)±0.013 inches (0.33 mm).

Oppositely located cutouts are provided on the body and provide extending flaps 118 and 120 projecting away from the clip. The cutouts are preferably positioned on the D₂ dimension.

A mount assembly 200 for a lamp comprises a glass stem 202 having a first barrel portion 204 that is tubular and has an outside diameter D. A second portion 206 is formed as a pinch seal, which is generally rectangular in cross-section. A frame clip 100 is mounted upon the barrel portion 204 by pressing the clip over the barrel. Since the dimension D₂ is larger than the largest dimension of the press-seal, the clip clearance is maintained. Thereafter, the dimension D₁ encounters the larger dimension of the barrel and spreads accordingly to provide the necessary interference fit.

Frame members 208 and 210 can then be attached to the projecting flaps 118 and 120 as is well known. The arc tube and its accompanying shield can then be mounted as known.

Alternatively, the arc tube and frame assembly can be attached to the clip first and then the entire assembly can be mounted upon the glass stem.

Utilization of the frame clip as described herein provides many advantages over the prior art. It significantly reduces manual assembly and thereby reduces ergonomic issues associated with installation and removal. It is easily removed for mount repairs if that should be necessary. Additionally, it reduces the cost and the risks to automate the assembly.

While there have been shown and described what are at present considered to be the preferred embodiments of the invention, it will be apparent to those skilled in the art that various changes and modification can be made herein without departing from the scope of the invention as defined by the appended claims.

1. A frame clip for mounting a light source in a lamp, said frame clip comprising a substantially oval body having a longitudinal axis with an opening therein parallel to said longitudinal axis and having a given height and a first inside dimension D₁ and a second inside dimension D₂, and wherein said second dimension D₂ is greater than D₁.

2. The frame clip of claim 1 wherein a pair of substantially oppositely located cutouts are provided on said body each providing an extending flap projecting away from said clip.

3. The frame clip of claim 2 wherein said cutouts are positioned on said second dimension.

4. The frame clip of claim 1 wherein said frame clip is constructed of stainless steel.

5. A mount assembly for a lamp comprising:
a glass stem having a first portion that is tubular and has an outside dimension D and a second portion formed as a pinch seal,
a frame clip mounted upon said first portion, said frame clip comprising a substantially oval body having a longitudinal axis with an opening therein parallel to said longitudinal axis and having a given height and a first inside dimension D₁ and a second inside dimension D₂, and wherein said second dimension D₂ is greater than D₁ and D₁ is less than D before said frame clip is mounted upon said glass stem and wherein said first and second dimensions D₁ and D₂ are substantially equal to D after mounting.

6. The mount assembly of claim 5 wherein a pair of substantially oppositely located cutouts is formed in said clip, each providing an extending flap projecting away from said frame clip, and
a first frame member affixed to a first of said flaps and a second frame member affixed to a second of said flaps.
